(19) United States
(12) Patent Application Publication
(10) Pub. No.: US 2014/0356780 A1
(43) Pub. Date: Dec. 4, 2014

(54) TONER FOR ELECTROSTATIC IMAGE DEVELOPMENT AND PRODUCTION PROCESS OF THE SAME

(71) Applicant: Konica Minolta, Inc., Tokyo (JP)

(72) Inventors: Takaki Kawamura, Tokyo (JP); Kaori Matsushima, Tokyo (JP); Aya Shirai, Tokyo (JP); Taiki Amemiya, Tokyo (JP)

(73) Assignee: Konica Minolta, Inc., Tokyo (JP)

(21) Appl. No.: 14/288,522

(22) Filed: May 28, 2014

(30) Foreign Application Priority Data
Jun. 4, 2013 (JP) 2013-117671

(51) Int. Cl. G03G 9/087; G03G 9/08

(52) U.S. Cl. CPC G03G 9/08724; G03G 9/0804
USPC 430/109.3; 430/137.14

(57) ABSTRACT

Provided is a toner for electrostatic image development that has low-temperature fixability and long-term stable electrification performance, also has heat-resistant storage stability, and can suppress the occurrence of unevenness in gloss. Also provided is a production process of the toner. The toner for electrostatic image development includes toner particles having a domain-matrix structure. In the toner particles, a crystalline polyester resin and an amorphous resin including an amorphous polyester segment and a polymerized vinyl segment that are chemically bonded are dispersed as domain phases in a matrix phase formed of a vinyl resin.

### TECHNICAL FIELD

The present invention relates to a toner for electrostatic image development that is used in image formation of an electrophotographic system, and a production process of the same.

### BACKGROUND ART

Recently, to achieve higher energy saving in image forming apparatuses of an electrophotographic system, there is a need for a toner for electrostatic image development (hereinafter may be referred to simply as a “toner”) that is heat-fixable at lower temperature.

Such a toner is required to have better low-temperature fixability and also have long-term stable electrification performance so that high quality images can be formed for a long period of time.

For example, Patent Literature 1 discloses a toner in which a crystalline polyester resin serving as a fixing aid is contained in a binder resin such as a vinyl resin for the purpose of improving fixability.

However, with such a toner, the following problems occur unless the compatibility between the crystalline polyester resin and the binder resin is taken, into consideration. For example, a problem, when the compatibility between the crystalline polyester resin and the binder resin during heat fixation is high is that heat-resistant storage stability is low because plasticization of the binder resin proceeds before heat fixation. A problem when the compatibility between the crystalline polyester resin and the binder resin is low is that the crystalline polyester resin is separated and exposed at the surface of toner particles to cause a reduction in the charge property of the toner, so that image failures such as a reduction in image density and fogging occur. A problem when a combination of a crystalline material and an amorphous material is used is that the melt viscosity of the resins in the toner particles becomes non-uniform, so that unevenness in gloss occurs particularly when an image is formed on a rough paper sheet.

### CITATION LIST

### Patent Literature

Patent Literature 1: Japanese Patent Application Laid-open No. 2011-145587

### SUMMARY OF INVENTION

### Technical Problem

The present invention has been made on the basis of the foregoing circumstances and has as its object the provision of a toner for electrostatic image development that has low-temperature fixability and long-term stable electrification performance, also has heat-resistant storage stability, and suppresses the occurrence of unevenness in gloss. Another object is the provision of a production process of the toner for electrostatic image development.

### Solution to Problem

To achieve at least one of the above mentioned objects, a toner for electrostatic image development reflecting one aspect of the present invention is a toner for electrostatic image development, comprising toner particles having a domain-matrix structure, wherein,

in the toner particles, a crystalline polyester resin and an amorphous resin including an amorphous polyester segment and a polymerized vinyl segment that are chemically bonded are dispersed as domain phases in a matrix phase including a vinyl resin.

In the above mentioned toner for electrostatic image development, the mass ratio of the crystalline polyester resin to the amorphous resin that constitute the domain phases (the crystalline polyester resin/the amorphous resin) may preferably be 10/90 to 80/20.

In the above mentioned toner for electrostatic image development, the content of the crystalline polyester resin with respect to the total amount of the resins forming the toner particles may preferably be 5 to 30% by mass.

In the above mentioned toner for electrostatic image development, the content of the polymerized vinyl segment in the amorphous resin may preferably be 5 to 30% by mass.

In the above mentioned toner for electrostatic image development, the polymerised vinyl segment may preferably have a structural unit derived from a (meth)acrylate-based monomer represented by a following general formula (1):

H₂C═CR¹—COOR² general formula (1)

[in the general formula (1), R¹ represents a hydrogen atom or a methyl group, and R² represents an alkyl group having 1 to 8 carbon atoms].

In the above mentioned toner for electrostatic image development, an ester group concentration in the crystalline polyester resin may preferably be 0.1 to 7.1 mmol/g.

To achieve at least one of the above mentioned objects, a production process of a toner for electrostatic image development reflecting one aspect of the present invention comprises a step of aggregating and fusion-bonding fine particles of a vinyl resin, fine particles of an amorphous resin including an amorphous polyester segment and a polymerized vinyl segment that are chemically bonded and fine particles of a crystalline polyester resin in a water-based medium.

In the above mentioned production process of a toner for electrostatic image development, the polymerized vinyl segment may preferably have a structural unit derived from a (meth)acrylate-based monomer represented by a following general formula (1):

H₂C═CR¹—COOR² general formula (1)

[in the general formula (1), R¹ represents a hydrogen atom, or a methyl group, and R² represents an alkyl group having 1 to 8 carbon atoms].

In the above mentioned production process of a toner for electrostatic image development, an ester group concentration in the crystalline polyester resin may preferably be 0.1 to 7.1 mmol/g.

### Advantageous Effects of Invention

In the above mentioned toner for electrostatic image development, the toner particles have a domain-matrix structure in which a crystalline polyester resin and an amorphous resin including an amorphous polyester segment and a polymerized vinyl segment that are chemically bonded form domain phases and are dispersed in a matrix phase formed of a vinyl resin. Therefore, the toner has low-temperature fixability and long-term stable electrification performance and also has heat-resistant storage stability, and the occurrence of unevenness in gloss is suppressed.

With the above mentioned production process of a toner for electrostatic image development, toner particles having a domain-matrix structure in which a crystalline polyester resin and an amorphous resin including an amorphous polyester segment and a polymerised vinyl segment that are chemically bonded are dispersed as domain phases in a matrix phase formed of a vinyl resin can be produced in a reliable manner.

### BRIEF DESCRIPTION OF DRAWING

FIG. 1 is a diagram illustrating an example of a cross section of a particle of the toner for electrostatic image development according to the present invention.

### DESCRIPTION OF EMBODIMENTS

The present invention, will next foe described in detail.

### Toner:

The toner of the present invention includes toner particles containing at least a binder resin, and the toner particles may contain additional toner components such as a colorant, a magnetic powder, a parting agent and a charge control agent as needed. In addition, external additives such as a flowability improver and a cleaning aid may be added to the toner particles.

The toner particles according to the toner of the present invention have a domain-matrix structure in which domain phases are dispersed in a matrix phase.

In the toner of the present invention, the domain phases are formed of at least two types of resins, i.e., an amorphous resin and a crystalline polyester resin.

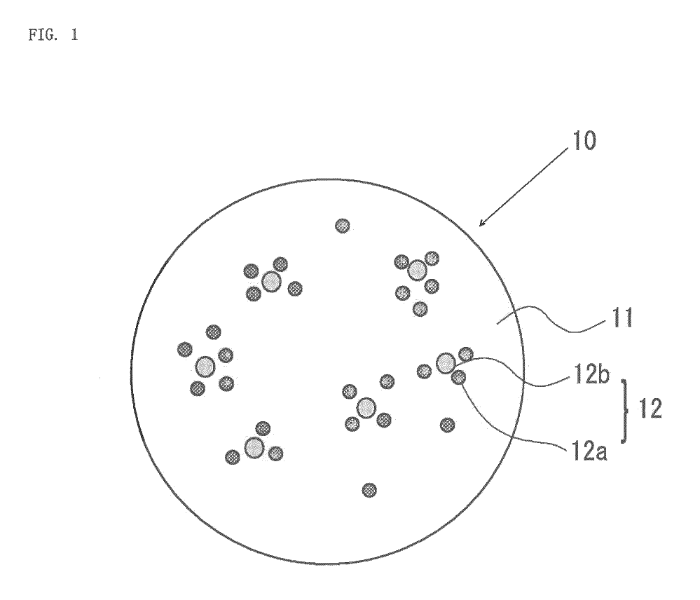

More specifically, as shown in FIG. 1, a toner particle 10 has a structure in which domain phases 12 formed of two types of resins, i.e., a first domain phase 12a formed of the amorphous resin and a second domain phase 12b formed of the crystalline polyester resin, are individually dispersed in a matrix phase 11 formed of a vinyl resin.

In the toner particles 10, the affinity between a polymerized vinyl segment part in the amorphous resin and the vinyl resin constituting the matrix phase 11 is high, and the affinity between an amorphous polyester segment part in the amorphous resin and the crystalline polyester resin constituting the second domain phase 12b is high. Therefore, many domains of the first domain phase 12a formed of the amorphous resin are present around domains of the second domain phase 12b formed of the crystalline polyester resin, as shown in FIG. 1.

The domain-matrix structure is a structure in which the domain phases having closed boundaries (boundaries between phases) are present in the continuous matrix phase.

Such a structure can be observed in cross-sectioned toner particles stained with ruthenium (VIII) oxide or osmium (VIII) oxide under a transmission electron microscope (TEM) using a measurement method known per se in the art. When an ultramicrotome is used to cut a slice, the thickness of the slice is set to 100 nm.

In the toner particles 10 according to the toner of the present invention, the average diameter of the first domain phase 12a formed of the amorphous resin is preferably 50 to 1,000 nm, more preferably 50 to 300 nm.

The average diameter of the second domain phase 12b formed of the crystalline polyester resin is preferably 50 to 1,000 nm, more preferably 50 to 300 nm.

The average diameter of the domain phase is a value measured on an image observed under the transmission electron microscope (TEH). More specifically, in the observed TEM image, the average of the horizontal Feret diameter and vertical Feret diameter of each domain of the domain phase is used as the diameter of the each domain, and the average of the diameters of the domains of the domain phase is computed, as the average diameter of the domain phase.

### Binder Resin:

The binder resin constituting the toner particles according to the present invention comprises the vinyl resin, forming the matrix phase, the amorphous resin and the crystalline polyester resin that form the domain phases and may contain other resins.

### Vinyl Resin:

The vinyl resin constituting the matrix phase is an amorphous resin formed using a monomer having a vinyl group (hereinafter may be referred to as a “vinyl monomer”).

As examples of the vinyl resin, may be mentioned a styrene resin, an acrylic resin, and a styrene-acrylic copolymer resin. A styrene-acrylic copolymer resin is preferable.

The following monomers etc. can be used as the vinyl monomer. Such vinyl monomers may be used either singly or in any combination thereof.

### (1) Styrene-Based Monomers

Styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, derivatives thereof, etc.

### (2) (Meth)acrylate-Based Monomers

Methyl (meth)acrylate, ethyl (meth)acrylate, n-butyl (meth)acrylate, isopropyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, phenyl (meth)acrylate, diethylaminoethyl (meth)acrylate, dimethylaminoethyl (meth)acrylate, derivatives thereof, etc.

### (3) Vinyl Esters

Vinyl propionate, vinyl acetate, vinyl benzoate, etc.

### (4) Vinyl Ethers

Vinyl methyl ether, vinyl ethyl ether, etc.

### (5) Vinyl Ketones

Vinyl methyl ketone, vinyl ethyl ketone, vinyl hexyl ketone, etc.

### (6) N-Vinyl Compounds

N-vinylcarbazole, N-vinylindole, N-vinylpyrrolidone, etc.

### (7) Others

Vinyl compounds such as vinylnaphthalene and vinylpyridine, derivatives of acrylic acid and methacrylic acid such as acrylonitrile, methacrylonitrile and acrylamide, etc.

The vinyl monomer used is preferably a monomer having an ionic leaving group such as a carboxy group, a sulfonate group or a phosphate group. Specific examples include the following monomers.

As examples of the monomer having a carboxy group, may be mentioned acrylic acid, methacrylic acid, maleic acid, itaconic acid, cinnamic acid, fumaric acid, maleic acid monoalkyl esters and itaconic acid monoalkyl esters. As examples of the monomer having a sulfonate group, may be mentioned styrenesulfonic acid, allyl sulfosuccinic acid and 2-acrylamide-2-methylpropane sulfonic acid. As examples of the monomer having a phosphate group, may be mentioned acidphosphoxyethyl methacrylate.

In the present invention, when the monomer having an ionic leaving group is used as the vinyl monomer, the ratio of the monomer having an ionic leaving group to all the vinyl monomers is preferably 2 to 7% by mass. If the ratio of the monomer having an ionic leaving group is excessively high, the amount of water adsorbed on the surface of the toner particles becomes large. In this case, toner blisters may occur, and the environmental difference in the amount of charge may increase.

In addition, a polyfunctional vinyl may be used as a vinyl monomer to allow the vinyl resin to have a cross-linked structure. As examples of the polyfunctional vinyl, may be mentioned divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate and neopentyl glycol diacrylate.

The glass transition point (Tg) of the vinyl resin is preferably 25 to 70° C., more preferably 40 to 60° C.

When the glass transition point of the vinyl resin fails within the above range, both sufficient low-temperature fixability and heat-resistant storage stability are achieved simultaneously in a reliable manner.

If the glass transition point of the vinyl resin is excessively low, the heat resistance (thermal strength) of the toner deteriorates. In this case, sufficient heat-resistant storage stability and hot offset, resistance may not be obtained. If the glass transition point of the vinyl resin is excessively high, sufficient low-temperature fixability may not be obtained.

The glass transition point (Tg) of a vinyl resin is a value measured using “Diamond DSC” (manufactured by PerkinElmer Co., Ltd.).

The procedure of the measurement will next be described. First, 3.0 mg of a measurement sample (the vinyl resin) is sealed in an aluminum-made pan, and the pan is placed in a holder. An empty aluminum-made pan is used as a reference. A Heat-cool-Heat cycle is performed in the measurement temperature range of 0 to 200° C. while the temperature is controlled under the measurement conditions of a temperature increase rate of 10° C./min and a temperature decrease rate of 10° C./min. Analysis performed using data in the 2nd heating, and the intersection of the extension of a base line before the rising edge of a first endothermic peak and a tangential line representing the maximum inclination, between the rising edge of the first endothermic peak and the top of the peak is used as the glass transition point.

The weight-average molecular weight (Mw) of the vinyl resin measured by gel permeation chromatography (GPC) is preferably 10,000 to 60,000.

The molecular weight of the vinyl resin measured by gel permeation chromatography (GPC) is a value measured, as follows.

The molecular weight is measured using an apparatus “HLC-8120GPC” (manufactured by TOSOH Corporation) and a column “TSKguardcolumn+TSKgel SuperHZM-M (three in series)” (manufactured by TOSOH Corporation) in the flow of tetrahydrofuran (THF) used as a carrier solvent at a flow rate of 0.2 mL/min while the temperature of the column is held at 40° C. The measurement sample (the vinyl resin) is dissolved in tetrahydrofuran at a concentration of 1 mg/mL using an ultrasonic disperser. In this case, the dissolving treatment is performed at room temperature for 5 minutes. Next, the obtained solution is treated through a membrane filter having a pore size of 0.2 μm to obtain a sample solution, and 10 μL of the sample solution together with the above-described carrier solvent is injected into the apparatus. Detection is performed using a refractive index detector (RI detector), and the molecular weight distribution of the measurement sample is computed, using a calibration curve determined using monodispersed polystyrene standard particles. Ten different types of polystyrene were used for the determination of the calibration curve.

The content of the vinyl resin with respect to the total mass of the resins constituting the toner particles, i.e., in the binder resin, is preferably 50 to 90% by mass.

When the content of the vinyl resin falls within the above range, the high elasticity of the vinyl resin becomes apparent, and excellent post-fixing separability can be achieved.

### Amorphous Resin:

The amorphous resin constituting the domain phase is a hybrid resin including an amorphous polyester segment and a polymerized vinyl segment that are chemically bonded. More specifically, in the amorphous resin, the amorphous polyester segment and the polymerized vinyl segment are bonded through a monomer reactive with both of them (hear in after may be referred to simply as a “both-reactive monomer”).

The polymerized vinyl segment is formed from a vinyl monomer. As examples of the vinyl monomer, may be mentioned: styrene-based monomers such as styrene, o-methylstyrene, m-methyl styrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene and 3,4-dichlorostyrene; and (meth)acrylate-based monomers such as methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate and diethylaminoethyl methacrylate. In addition, those exemplified as the vinyl monomers for forming the vinyl resin described above may be used. These vinyl monomers may be used either singly or in any combination thereof.

Particularly, the polymerized vinyl segment includes preferably a structural unit derived from a (meth)acrylate-based monomer represented by the general formula (1) above, in the general formula (1), R¹ represents a hydrogen atom or a methyl group and is particularly preferably a hydrogen atom. R² represents an alkyl group having 1 to 8 carbon atoms.

The (meth)acrylate-based monomer represented by the general formula (1) above has nigh polarity with respect to water. Therefore, when the domain phases are formed in the production process of the toner using a water-based medium described later, the polymerized vinyl segment parts in the amorphous resin are oriented toward the water-based medium, and the amorphous polyester segment parts are oriented toward the crystalline polyester resin. A larger number of domains of the first domain phase 12a formed of the amorphous resin are thereby allowed to be present around domains of the second domain phase 12b formed of the crystalline polyester resin. In addition, the domains of the first domain phase 12a formed of the amorphous resin are formed so as to surround the domains of the second domain phase 12b formed of the crystalline polyester resin. Therefore, exposure of the crystalline polyester resin at the surface of the toner is suppressed, and therefore long-term, stable electrification performance can be achieved in a more reliable manner.

The amorphous polyester segments are formed from a polyvalent carboxylic acid and a polyhydric alcohol and do not show a clear endothermic peak in differential scanning calorimetry (DSC). Specifically, the clear endothermic peak is an endothermic peak with a half-value width of 15° C. or less in differential scanning calorimetry (DSC) when the measurement is performed at a temperature increase rate of 10° C./min.

As examples of the polyvalent carboxylic acid, may be mentioned: aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acrd, 1,14-tetradecanedicarbonylic acid, 1,16-hexadecanedicarboxylic acid and 1,18-octadecanedioarboxylic acid; aromatic dicarboxylic acids such as phthalic acid, isophthalic acid, terephthalic acid and naphthalene dicarboxylic acid; unsaturated aliphatic dicarboxylic acids such as maleic acid, fumaric acid, itaconic acid, citraconic acid, glutaconic acid, isododecenyl succinic acid, n-dodecenyl succinic acid and n-octenyl succinic acid; and divalent and higher carboxylic acids such as trimellitic acid, pyromellitic acid, naphthalene tricarboxylic acid, naphthalene tetracarboxylic acid, pyrene tricarboxylic acid and pyrene tetracarboxylic acid. Other examples may include acid anhydrides and acid chlorides of these polyvalent carboxylic acids.

As examples of the polyhydric alcohol, may be mentioned: aliphatic diols such as ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol and 1,20-eicosanediol; bisphenols such as bisphenol A and bisphenol F and alkylene oxide adduces of these bisphenols such as ethylene oxide adducts and propylene oxide adduces; and trihydric or higher alcohols such as glycerin, pentaerythritol, hexamethylolmelamine, hexaethylolmelanine, tetramethylolbenzoguanamine and tetraethylolbenzoguanamine.

The content of the polymerised vinyl segment in the amorphous resin, is preferably 5 to 30% by mass, more preferably 5 to 20% by mass.

More specifically, the content of the polymerised vinyl segment is the mass ratio of the vinyl monomer to the total mass of the resin materials used to synthesize the amorphous resin, i.e., the total mass of the polyvalent carboxylic acid and the polyhydric alcohol that form the amorphous polyester segment, the vinyl monomer forming the polymerized vinyl segment, and the both-reactive monomer for bonding these segments.

When the content of the polymerized vinyl segment fails within the above range, the structure of the toner particles can be easily controlled.

If the content of the polymerized vinyl segment is less than 5% by mass, entanglement of polymer chains at the interface with the vinyl resin constituting the matrix phase is reduced, so that image strength may deteriorate. If the content of the polymerized vinyl segment exceeds 30% by mass, the domain-matrix structure is not easily formed.

To produce the amorphous resin described above, any existing general scheme may be used. The following three methods are representative methods.

(1) A method including subjecting the vinyl monomer for forming the polymerised vinyl segment to an addition polymerization reaction, then subjecting the polyvalent carboxylic acid and polyhydric alcohol for forming the amorphous polyester segment to a condensation polymerization reaction, and, if necessary, adding a trivalent or higher vinyl monomer used as a cross-linking agent to the reaction system to allow the condensation polymerization reaction to further proceed.

(2) A method including subjecting the polyvalent carboxylic acid and polyhydric alcohol for forming the amorphous polyester segment to a condensation polymerization reaction, then subjecting the vinyl monomer for forming the polymerized vinyl segment to an addition polymerisation reaction, and, if necessary, adding a trivalent or higher vinyl monomer used as a cross-linking agent to the reaction system to allow the condensation polymerization reaction to further proceed under a temperature condition suitable for the condensation polymerization reaction.

(3) A method including subjecting the vinyl monomer for forming the polymerized vinyl segment to an addition polymerization reaction under a temperature condition suitable for the addition polymerization reaction, simultaneously subjecting the polyvalent carboxylic acid and polyhydric alcohol for forming the amorphous polyester segments to a condensation polymerization reaction, and, if necessary, after completion of the addition polymerization reaction, adding a trivalent or higher vinyl monomer used as a cross-linking agent to the reaction system to allow the condensation polymerization reaction to farther proceed under a temperature condition suitable for the condensation polymerization reaction.

In the amorphous resin, the amorphous polyester segment and the polymerised vinyl segment are bonded through the both-reactive monomer. Therefore, in a specific production method, for example, the monomer reactive with them is used together with the polyvalent carboxylic acid-the polyhydric alcohol and/or the vinyl monomer, and the condensation polymerisation reaction is performed in the presence of the polyvalent carboxylic acid and the polyhydric alcohol at least one of before, during and after the step of addition polymerisation of the vinyl monomer.

The both-reactive monomer is preferably a compound having, in its molecule, at least one functional group selected from the group consisting of a hydroxyl group, a carboxyl group, an epoxy group, a primary amino group and a secondary amino group, preferably a hydroxyl group and/or a carboxyl group, more preferably a carboxyl group and an ethylenic unsaturated bona, i.e., a vinyl-based carboxylic acid. As specific examples of the both-reactive monomer, may be mentioned acrylic acid, methacrylic acid, fumaric acid and maleic acid. The both-reactive monomer may be a hydroxyalkyl (having 1 to 3 carbon atoms) ester of any of these compounds. From the viewpoint of reactivity, acrylic acid, methacrylic acid, and fumaric acid are preferred.

From the viewpoint of durability, it is preferable to use a monovalent vinyl-based carboxylic acid as the both-reactive monomer rather than a polyvalent vinyl-based carboxylic acid. This may be because, since the monovalent vinyl-based carboxylic acid is highly reactive with the vinyl monomer, they can foe easily hybridized. When a dicarboxylic acid such as fumaric acid is used as the both-reactive monomer, durability becomes slightly lower. This may be because, since the reactivity of the dicarboxylic acid with the vinyl monomer is low, they are not easily hybridized uniformly, and so a domain structure is formed.

From the viewpoint of improving the low-temperature fixability, high-temperature offset resistance and curability of the toner, the amount used of the both-reactive monomer is 1 to 10 parts by mass, more preferably 4 to 8 parts by mass per 100 parts by mass of the total mass of the vinyl monomer and preferably 0.3 to 8 parts by mass, more preferably 0.5 to 5 parts by mass per 100 parts by mass of the total mass of the polyvalent carboxylic acid and the polyhydric alcohol.

The addition polymerisation reaction may be performed in an organic or inorganic solvent in the presence of, for example, a radical polymerization initiator and a cross-linking agent according to a method known per so in the art under the temperature condition of preferably 110 to 200° C., more preferably 140 to 180° C. As examples of the radical polymerisation initiator, may be mentioned dialkyl peroxides, dibutyl peroxide and butylperoxy-2-ethylhexyl monocarboxylic acid. These may be used either singly or in any combination thereof.

The condensation polymerization reaction may be performed, for example, under the temperature condition of 180 to 250° C. in an inert gas atmosphere and is preferably performed in the presence of an esterification catalyst, a polymerization inhibitor, etc. As examples of the esterification catalyst, may be mentioned dibutyl tin oxide, titanium compounds and tin(II) compounds having no Sn—C bond such as tin octanoate. These may be used either singly or in any combination thereof.

In the amorphous resin constituting the domain phase, the affinity of the polymerised vinyl segment part of the amorphous resin for the vinyl resin forming the matrix phase is high, and the affinity of the amorphous polyester segment part of the amorphous resin for the crystalline polyester resin described later is high. Therefore, in the toner of the present invention, although a combination of the crystalline material and the amorphous material is used, the overall affinity in the toner particles is high, and nonuniformity in melt viscosity of the resins in the toner particles is small. Particularly, the occurrence of unevenness in gloss on a rough paper sheet can be suppressed.

The glass transition point (Tg) of the amorphous resin is preferably 30 to 65° C., more preferably 35 to 60° C.

The weight average molecular weight (Mw) of the amorphous resin measured by gel permeation chromatography (GPC) is preferably 10,000 to 25,000, and its number average molecular weight (Mn) is preferably 2,000 to 4,000.

The glass transition point of the amorphous resin and its molecular weights measured by gel permeation chromatography (GPC) are measured in the same manners as described above except that the amorphous resin is used as the measurement sample.

The softening point (Tsp) of the amorphous resin is preferably 90 to 115H, more preferably 90 to 105° C.

The softening point (Tsp) of the amorphous resin is a value measured as follows.

First, 1.1 g of a measurement sample (the amorphous resin) is placed in a petri dish in an environment of 20±1° C. and 50±5% RH and then is leveled off. After left to stand for 12 hours or longer, the measurement sample is pressurized using a press “SSP-10A” (manufactured by Shimadzu Corporation) at a pressure of 3,320 kg/cm² for 30 seconds to produce a cylindrical molded sample having a diameter of 1 cm. Then the molded sample is placed in a flow tester “CFT-500D” (manufactured by Shimadzu Corporation) in an environment of 24±5° C. and 50±20% RH. Under the conditions of a load of 196 N (20 kgf), a start temperature of 60° C., a preheating time of 300 seconds and a temperature increase rate of 6° C./min, the molded sample is extruded from the hole (1 mm diameter×1 mm) of a cylindrical die using a piston having a diameter of 1 cm after completion of preheating. An offset temperature T_{offset} measured by a melting point measurement method using a temperature rise method at an offset value setting of 5 mm is used as the softening point.

### Crystalline Polyester Resin:

The crystalline polyester resin constituting the domain phase is any known polyester resin obtained, by a polycondensation reaction of a divalent or higher carboxylic acid (polyvalent carboxylic acid) and a dihydric or higher alcohol (a polyhydric alcohol) and showing a clear endothermic peak rather than a stepwise endothermic change in differential scanning calorimetry (DSC). Specifically, the clear endothermic peak is an endothermic peak with a half-value width of 15° C. or less in differential scanning calorimetry (DSC) when the measurement is performed at a temperature increase rate of 10° C./min.

The polyvalent carboxylic acid is a compound having two or more carboxy groups in its molecule.

As specific examples of the polyvalent carboxylic acid, may be mentioned: saturated aliphatic dicarboxylic acids such as oxalic acid, malonic acid, succinic acid, adipic acid, sebacic acid, azelaic acid and n-dodecylsuccinic acid; alicyclic dicarboxylic acids such as cyclohexane dicarboxylic acid; aromatic dicarboxylic acids such as phthalic acid, isophthalic acid and terephthalic acid; trivalent or higher polyvalent carboxylic acids such as trimellitic acid and pyromellitic acid; and anhydrides and C1 to C3 alkyl esters of these carboxylic acid compounds.

These may be used either singly or in any combination thereof.

The polyhydric alcohol is a compound having two or more hydroxy groups in its molecule.

As specific examples of the polyhydric alcohol, may be mentioned: aliphatic diols such as 1,2-propanediol, 1,3-propanediol, 1,4-butanediol, 1,5-pentanediol, 1,6-hexanediol, 1,7-heptanediol, 1,8-octanediol, neopentyl glycol and 1,4-butenediol; and trihydric or higher alcohols such as glycerin, pentaerythritol, trimethylolpropans and sorbitol.

These may be used either singly or in any combination thereof.

The ester group concentration in the crystalline polyester resin is preferably 0.1 to 7.1 mmol/g, more preferably 3.0 to 7.1 mmol/g.

When the ester group concentration in the crystalline polyester resin falls within the above range, the polymerized vinyl segment parts in the amorphous resin are oriented toward the water-based medium and tine amorphous polyester segment parts are oriented toward the crystalline polyester resin when the domain phases are formed in the production process of the toner in a water-based medium described later. Therefore, a larger number of domains of the first domain phase 12a formed of the amorphous resin are allowed to be present, around domains of the second domain phase 12b formed of the crystalline polyester resin. In addition, the domains of the first domain phase 12a formed of the amorphous resin are formed so as to surround the domains of the second domain phase 12b formed of the crystalline polyester resin. Therefore, exposure of the crystalline polyester resin at the surface of the toner is suppressed, and therefore long-term stable electrification performance can be achieved in a more reliable manner. In addition, the crystalline polyester resin is immiscible with the vinyl resin constituting the matrix phase. Therefore, heat-resistant storage stability can be reliably ensured.

If the ester group concentration in the crystalline polyester resin is excessively small, the affinity for the vinyl resin becomes roc small, so that an interface may be formed after heat fixation. In this case, image strength may be reduced, and the image may be cracked at the interface. If the ester group concentration in the crystalline polyester resin is excessively high, the crystalline polyester resin is miscible with the vinyl resin, and a reduction in heat-resistant storage stability may occur.

The ester group concentration used herein is the ratio of ester groups (ester bonds) in the crystalline polyester resin and represents the degree of affinity for water. The higher the value of the ester group concentration is, the higher the affinity for water is.

In the present invention, the ester group concentration is a value computed using the following formula (1):

ester group concentration=[the average of the numbers of moles of portions capable of forming ester groups and included in the polyvalent carboxyl acid and the polyhydric alcohol forming the crystalline polyester resin/((the sum total of the molecular weight of the polyvalent carboxyl acid and the molecular weight of the polyhydric alcohol)−(the molecular weight of water separated by dehydration polycondensation×the number of moles of ester groups))]×1000 Formula (1)

The ester group concentration in the crystalline polyester resin can be controlled by changing the types of the monomers.

An example of the computation of the ester group concentration in the crystalline polyester resin is shown below.

A crystalline polyester resin obtained from a polyvalent carboxyl acid represented by the following formula (a) and a polyhydric alcohol represented by the following formula (b) is represented by the following formula (c).

HOOC—R³—COOH Formula (a)

HO—R⁴—OH Formula (b)

—(—OCO—R³—COO—R⁴—)ₙ— Formula (c)

“The average of the numbers of moles of portions capable of forming ester groups and included in the polyvalent carboxyl acid and the polyhydric alcohol forming the crystalline polyester resin” is the average of the number of moles of carboxy groups in the polyvalent carboxyl acid forming the crystalline polyester resin and the number of moles of hydroxyl groups in the polyhydric alcohol forming the crystalline polyester resin. More specifically, this value is the average of the number of moles of carboxy groups in the polyvalent carboxyl acid of formula (a), i.e., “2,” and the number of moles of hydroxy groups in the polyhydric alcohol of formula (b), i.e., “2,” and is therefore “2.”

Let the molecular weight of the polyvalent carboxyl acid of the formula (a) be m1, the molecular weight of the polyhydric alcohol of the formula (b) be m2, and the molecular weight of the crystalline polyester resin of the formula (c) be m3. Then “(the sum total of the molecular weight of the polyvalent carboxyl acid and the molecular weight, of the polyhydric alcohol)−(the molecular weight of water separated by dehydration polycondensation×the number of moles of ester groups)” is (m1+m2)−(18×the average number of moles of ester groups, i.e., “2”) and is therefore equal to the molecular weight “m3” of the crystalline polyester resin of the formula (c).

Accordingly, the ester group concentration in the crystalline polyester resin represented by the formula (c) is “2/m3.”

When two or more types of polyvalent carboxyl acids are used, the average of the numbers of moles of carboxy groups in the polyvalent carboxyl acids and the average of their molecular weights are used. When two or more types of polyhydric alcohols are used, the average of the numbers of moles of hydroxyl groups in the polyhydric alcohols and the average of their molecular weights are used.

The melting point (Tm) of the crystalline polyester resin is preferably 40 to 95° C., more preferably 50 to 85° C.

When the melting point of the crystalline polyester resin falls within the above range, sufficient low-temperature fixability and high hot offset resistance are obtained.

If the melting point of the crystalline polyester resin is excessively low, the thermal strength of the obtained toner becomes low, so that sufficient heat-resistant storage stability and hot offset resistance may not be obtained. If the melting point of the crystalline polyester resin is excessively high, sufficient low-temperature fixability may not be obtained.

The melting point of the crystalline polyester resin can be controlled by changing the composition of the resin.

The melting point (Tm) of the crystalline polyester resin is a value measured as follows.

The melting point of the crystalline polyester is the temperature of the peak top of an endothermic peak and determined by DSC measurement in differential scanning calorimetry using “Diamond DSC” (manufactured by PerkinElmer Co., Ltd.).

More specifically, 1.0 mg of a measurement sample (the crystalline polyester resin) is sealed in an aluminum-made pan (KITNO. B0143013), and the pan is placed in a sample holder of the “Diamond DSC.” A heating-cooling-heating cycle is performed in the measurement temperature range of 0 to 200° C. while the temperature is controlled under the measurement conditions of a temperature increase rate of 10° C./min and a temperature decrease rate of 10° C./min. Analysis is performed using data in the second heating.

The weight average molecular weight (Mw) of the crystalline polyester resin measured by gel permeation chromatography (GPC) is preferably 5,000 to 50,000, and its number average molecular weight (Mn) is preferably 1,500 to 25,000.

The molecular weights of the crystalline polyester resin measured by gel permeation chromatography (GPC) are measured in the same manner as described above except that the crystalline polyester resin is used as the measurement sample.

The content of the crystalline polyester resin in the binder resin (with respect to the total mass of the resins) is preferably 5 to 30% by mass, more preferably 5 to 20% by mass.

When the content of the crystalline polyester resin falls within the above range, low-temperature fixability can be reliably obtained.

If the content of the crystalline polyester resin is excessively low, sufficient low-temperature fixation, effect is not obtained. If the content of the crystalline polyester resin is excessively high, plasticization of the vinyl resin is excessively facilitated, and this may cause an adverse effect on heat-resistant storage stability.

The content of the domain phases, i.e., the total content of the crystalline polyester resin and the amorphous resin, in the binder resin, is preferably 5 to 50% by mass, more preferably 10 to 30% by mass.

When tire content of the domain phases falls within the above range, low-temperature fixability can be reliably obtained. In addition, the heat-resistant storage stability and charge stability due to the vinyl resin can be ensured.

If the content of the domain phases is excessively small, sufficient low-temperature fixability may not be obtained. If the content of the domain phases is excessively nigh, plasticization of the vinyl resin, is excessively facilitated, and this may cause an adverse effect on heat-resistant storage stability.

The mass ratio of the crystalline polyester resin to the amorphous resin (the crystalline polyester resin/the amorphous resin) is preferably 10/90 to 80/20, more preferably 50/50 to 80/20.

When the mass ratio (the crystalline polyester resin/the amorphous resin) falls within the above range, the crystalline polyester resin can be introduced into the toner particles in such an amount that low-temperature fixability can be achieved.

If the mass ratio (the crystalline polyester resin/the amorphous resin) is excessively high, i.e., the ratio of the crystalline polyester resin is excessively high, the crystalline polyester resin may be exposed at the surface, and the charge property may deteriorate. If the mass ratio (the crystalline polyester resin/the amorphous resin) is excessively low, i.e., the ratio of the crystalline polyester resin, is excessively low, a sufficient amount of the crystalline polyester resin cannot be introduced into the toner particles, and so sufficient low-temperature fixability may not be obtained.

### Colorant:

In the toner of the present invention, when the toner particles are configured to contain a colorant, the colorant may be contained in any of the matrix phase and the domain phases.

Any of various colorants such as carbon black, dyes and pigments can be used as the colorant.

As examples of the carbon black, may be mentioned channel black, furnace black, acetylene black, thermal black and lamp black. As examples of black iron oxide, may be mentioned magnetite, hematite and iron titanium trioxide.

As examples of the dye, may be mentioned C.I. Solvent Red: 1, 49, 52, 58, 63, 111 and 122, C.I. Solvent Yellow: 19, 44, 77, 79, 81, 82, 93, 98, 103, 104, 112 and 162 and C.I. Solvent Blue: 25, 36, 60, 70, 93 and 95.

As examples of the pigment, may be mentioned C.I. Pigment Reds 5, 48:1, 48:3, 53:1, 57:1, 81:4, 122, 139, 144, 149, 150, 166, 177, 178, 222, 238 and 263, C.I. Pigment Orange: 31 and 43, C.I. Pigment Yellow: 14, 17, 74, 93, 34, 138, 155, 156, 138, 180 and 185, C.I. Pigment Greene 7 and C.I. Pigment Blue: 15:3 and 60.

One colorant or a combination of two or more colorants may be used for a color toner.

The content of the colorant in the toner particles is preferably 1 to 10% by mass, more preferably 2 to 8% by mass. If the content of the colorant is excessively small, the toner obtained may not have the desired coloring power. If the content of the colorant is excessively large, the colorant may be separated or adhere to a carrier etc., and this may affect charge property.

### [Parting Agent]

In the toner of the present invention, when the toner particles are configured to contain a parting agent, the parting agent may be contained in any of the domain phases and the matrix phase. Prom, the viewpoint of exudation of the parting agent from the surface during heat fixation, it is preferable that the parting agent is contained in the matrix phase.

Any of various publicly known waxes may be used as the parting agent.

Any of polyolefin-based waxes such, as low-molecular weight polypropylene wax, low-molecular weight polyethylene wax, oxidized-type polypropylene wax and oxidized-type polyethylene wax and ester-based waxes such as behenic acid behenate wax can be particularly preferably used.

As specific examples of the wax, may be mentioned; polyolefin waxes such as polyethylene wax and polypropylene wax; branched chain hydrocarbon waxes such as microcrystalline wax; long chain hydrocarbon-based waxes such as paraffin wax and Sasol wax; dialkyl ketone-based waxes such as distearyl ketone; ester-based waxes such as carnauba wax, montan wax, behenic acid behenate, trimethylolpropans tribehenate, pentaerythritol tetrabehenate, pentaerythritol diacetate dibehenate, glycerin tribehenate, 1,18-octadecanediol distearate, tristearyl trimellitate and distearyl maleate; and amide-based waxes such as ethylenediamine behenylamide and tristearyl trimellitate amide.

Of these, a wax having a low melting point, i.e., a melting point of 40 to 90° C., is preferably used from the viewpoint of releasability during low-temperature fixation.

The content of the parting agent in the toner particles is preferably 1 to 20% by mass, more preferably 5 to 20% by mass. When the content of the parting agent in the toner particles falls within the above range, releasability and fixability can be achieved simultaneously in a reliable manner

### Charge Control Agent:

In the toner of the present invention, when the toner particles are configured to contain a charge control, agent, the charge control agent may be contained in any of the domain phases and the matrix phase. From the viewpoint of the dispersibility of the charge control agent, it is preferable that the charge control agent is contained in the matrix phase.

Any of various publicly known compounds may be used as the charge control agent.

The content of the charge control agent in the toner particles is preferably 0.1 to 1.0% by mass, more preferably 0.5 to 5% by mass.

### External Additives:

The toner particles in the toner of the present invention can be used as the toner without adding any additive. However, to improve flowability, charge property, cleanability, etc., external additives such as a flowability improver and a cleaning aid may be added to the toner particles.

A combination of various external additives may be used.

The ratio of the total amount of the external additives added is preferably 0.05 to 5 parts by mass, more preferably 0.1 to 3 parts by mass per 100 parts by mass of the toner particles.

### Glass Transition Point of Toner:

The toner of the present invention has a glass transition point (Tg) of preferably 25 to 50° C., more preferably 25 to 45° C.

When the glass transition point of the toner of the present invention falls within, the above range, sufficient low-temperature fixability and heat-resistant storage stability are obtained simultaneously in a reliable manner. If the glass transition point of the tonner is excessively low, the heat resistance (thermal strength) of the toner deteriorates. In this case, sufficient neat-resistant storage stability and hot offset resistance may not be obtained. If the glass transition point of the toner is excessively high, sufficient low-temperature fixability may not be obtained.

The glass transition point of the toner is measured in the same manner as described above except that the toner is used as the measurement sample.

### Particle Diameter of Toner:

The average particle diameter, for example, the volume-based median diameter, of the toner of the present invention is preferably 3 to 8 μm, more preferably 5 to 8 μm. The average particle diameter can be controlled by changing the concentration of an aggregating agent used for production of the toner, the amount added of an organic solvent, fusion-bonding time, the chemical composition of the binder resin, etc.

When the volume-based median diameter falls within the above range, a very fine dot image of 1200 dpi can be faithfully reproduced.

The volume-based median diameter of the toner is measured and computed using a measuring device composed of “Multisizer 3” (manufactured by Beckman Coulter, Inc.) and a computer system connected thereto and equipped with data processing software “Software V3.51.” More specifically, 0.02 g of a measurement sample (the toner) is added to 20 mL of a surfactant solution (a surfactant solution used for the purpose of dispersing the toner particles and prepared, for example, by diluting a neutral detergent containing a surfactant component ten-fold with pure water) and is left to stand. The obtained solution is subjected to ultrasonic dispersion for 1 minute to prepare a dispersion of the toner. This toner dispersion is added with a pipette to a beaker containing “ISOTON II” (manufactured by Beckman Coulter, Inc.) and held in a sample stand until the concentration displayed in the measuring device reaches 8%. By using the above concentration range, a reproducible measurement value can be obtained. In the measuring device, the number of particles to be counted is set to 25,000, and the diameter of an aperture is set to 100 μm. The range of measurement, a 2 to 60 μm range, is divided into 256 sections, and a frequency value in each section is computed. The particle size when a cumulative volume fraction cumulated from the large-diameter side reaches 50% is used as the volume-based median diameter.

### Average Circularity of Toner:

In the toner of the present invention, the average circularity of the toner particles included in the toner is preferably 0.930 to 1.000, more preferably 0.950 to 0.995 from the viewpoint of stability of electrification characteristics and low-temperature fixability.

When the average circularity fails within the above range, individual toner particles are less likely to be broken. Therefore, contamination of a triboelectrifying member is suppressed, so that the charge property of the toner are stabilised. In addition, the quality of a formed image becomes high.

The average circularity of the toner is a value measured using “FPIA-2100” (manufactured by Sysmex Corporation).

More specifically, a measurement sample (the toner) is left to stand in a surfactant-containing aqueous solution and then subjected to ultrasonic dispersion treatment for 1 minute to disperse the toner. Then images of the toner are taken using the “FPIA-2100” (manufactured by Sysmex Corporation) in an HPF (high-power field) measurement mode at an appropriate concentration in which the number of particles detected in the HPF mode is 3,000 to 10,000. The circularity of each of the particles is computed using the following formula (y). The computed circularity values of the toner particles are summed up, and the sum total is divided by the total number of toner particles to compute the average circularity. When the number of particles detected in the HPF mode falls within the above range, reproducibility is obtained.

circularity=(the circumferential length of a circle having the same area as the projected area of a particle image)/(the circumferential length of the projected particle image) Formula (y)

### Developer:

The toner of the present invention can be used as a magnetic or non-magnetic one-component developer or may be mixed with a carrier and used as a two-component developer. When the toner is used as a two-component developer, the carrier used may be magnetic particles of a publicly known material such as a metal, for example, iron, ferrite or magnetite or an alloy of any of these metals with a metal such as aluminum or lead. Ferrite particles are particularly preferred. The carrier used may be a coated carrier prepared by coating the surface of magnetic particles with a coating agent such as a resin or a dispersion-type carrier prepared by dispersing a fine magnetic powder in a binder resin.

The volume-based median diameter of the carrier is preferably 20 to 100 μm, more preferably 25 to 80 μm. A representative example of the device used to measure the volume-based median diameter of the carrier is a laser diffraction-type particle size distribution measuring device “HELOS” (manufactured by SYMPATEC) equipped wish a wet-type dispenser.

In the present inventions to examine the ester group concentration in the crystalline polyester resin, the crystalline polyester resin contained in the toner particles must be extracted. More specifically, the resin can be extracted from the toner particles as follows.

First, the toner is dissolved in methyl ethyl ketone (MEK) at room temperature (20° C. or higher and 25° C. or lower). In this case, the resins in amorphous form (the vinyl resin and the amorphous resin) in the toner particles dissolve in MEK at room temperature. Therefore, the components dissolved in MEK include the resins in amorphous form, and the dissolved resins in amorphous form are obtained from a supernatant separated by centrifugation. The solids after centrifugation are heated at 65° C. for 60 minutes and dissolved in tetrahydrofuran (THF). The resultant, solution is filtrated through a glass filter at 60° C., and the crystalline polyester resin is obtained from the filtrate. If the temperature decreases curing filtration in the above procedure, the crystalline polyester resin may precipitate, and accordingly the procedure is performed while the temperature is maintained.

The ester group concentration in the crystalline polyester resin can be determined by hydrolyzing the crystalline polyester resin, performing measurement by P-GC/MS, and specifying the types of acid and alcohol monomers to compute the ester group concentration.

### Production Process of Toner:

As examples of the production process of the toner, which is not limited to particular ones, may be mentioned a wet production, process, such as an emulsion aggregation process, in which the toner is produced in a water-based medium.

In the production process of the toner of the present invention using the emulsion aggregation process, a water-based dispersion containing fine particles of the binder resin (hereinafter may be referred to as “fine binder resin particles”) dispersed in a water-based, medium is mixed with a water-based dispersion containing fine particles of the colorant (hereinafter may be referred to as “fine colorant particles”). Then the fine binder resin particles and the fine colorant particles are aggregated and heat-fused to form toner particles, whereby the toner is produced.

One example of the production process of the toner of the present invention will be described specifically.

The production process includes:

(a) a step of preparing a water-based dispersion containing fine particles of the vinyl resin (hereinafter may be referred to as “fine resin particles”) dispersed in a water-based medium;

(b) a step of preparing a water-based dispersion containing fine colorant particles dispersed in a water-based medium;

(c) a step of preparing a water-based dispersion containing fine particles of the amorphous resin (hereinafter may be referred to as “fine amorphous resin particles”) dispersed in a water-based medium;

(d) a step of preparing a water-based dispersion containing fine particles of the crystalline polyester resin (hereinafter may be referred to as “fine crystalline polyester resin particles”) in a water-based medium;

(e) a step of aggregating and fusion-bonding the fine resin particles, the fine amorphous resin particles, the fine crystalline polyester resin particles and the fine colorant particles in a water-based medium to form toner particles;

(f) a step of aging the toner particles using thermal energy to control their shape;

(g) a step of cooling the dispersion of the toner particles;

(h) a step of separating the toner particles from the water-based, medium by filtration to remove a surfactant etc. from, the toner particles;

(i) a step of drying the washed toner particles; and

(j) an optional step of adding external additives to the dried toner particles.

A “water-based dispersion” used herein is a dispersion containing a dispersoid (fine particles) dispersed in a water-based medium, and the water-based medium is a medium composed mainly of water (50% by mass or more). A component other than water may be an organic solvent soluble in water. As examples of such an organic solvent, may be mentioned methanol, ethanol, isopropanol, butanol, acetone, methyl ethyl ketone and tetrahydrofuran. Of these, alcohol-based organic solvents such as methanol, ethanol, isopropanol and butanol that are organic solvents not dissolving the resins are particularly preferred.

### (a) Step of Preparing Water-Based Dispersion, of Fine Resin Particles:

In this step, the water-based dispersion of the fine resin particles formed of the vinyl resin is prepared.

The water-based dispersion of the fine resin particles can be prepared by a miniemulsion polymerization process using the vinyl monomer for obtaining the vinyl resin. More specifically, for example, the vinyl monomer is added to a water-based medium containing a surfactant, and mechanical energy is applied thereto to form liquid droplets. Then a polymerization reaction is allowed to proceed in the liquid droplets via radicals from a water-soluble radical polymerization initiator. The liquid droplets may contain an oil-soluble polymerization initiator. The water-based dispersion of the fine resin particles formed of the vinyl resin can thereby be prepared.

The fine resin particles formed of the vinyl resin may have a multilayer structure including two or more layers composed of vinyl, resins with different compositions. The fine resin particles having such a structure, for example, a two-layer structure, can be obtained by the following process. A dispersion of resin particles is prepared by emulsion polymerization treatment (first polymerization) known per se in the art, and a polymerization initiator and a vinyl monomer are added to the dispersion. Then the resultant system is subjected to polymerisation treatment (second polymerization).

### Surfactant:

The surfactant used in this step may be any of various publicly known surfactants such as anionic surfactants, cat ionic surfactants and nonionic surfactants.

### Polymerization Initiator:

The polymerization initiator used in this step may be any of various publicly known polymerization initiators. As specific preferred examples of the polymerization initiator, may be mentioned persulfates (for example, potassium persulfate and ammonium persulfate). In addition, any of azo-based compounds (for example, 4,4′-azobis-4-cyanovaleric acid and salts thereof and 2,2-azobis(2-amidinopropane) salts), peroxide compounds and azobisisobutyronitrile may be used.

### Chain Transfer Agent:

In this step, any generally used chain transfer agent may be used for the purpose of controlling the molecular weight of the vinyl resin. No particular limitation is imposed on the chain transfer agent, and as examples thereof, may be mentioned 2-chloroethanol, mercaptans such as octyl mercaptan, dodecyl mercaptan and t-dodecyl mercaptan and a styrene dimer.

If necessary, the toner particles according to the present invention may contain, other internal additives such as a parting agent and a charge control agent. Such internal additives may be introduced into the toner particles by, for example, dissolving or dispersing the internal additives in the solution of the vinyl monomer for forming the vinyl resin in advance in this step.

Such internal additives may also be introduced into the toner particles as follows. A dispersion of internal additive particles composed only of the internal additives is prepared separately. Then the internal additive particles are aggregated in the toner particle forming step. However, it is preferable to use the method in which the internal additives are introduced in advance in this step.

The average particle diameter, i.e., the volume-based median diameter, of the fine resin particles is preferably within the range of 20 to 400 nm.

The volume-based median diameter of the fine resin particles is a value measured using “Microtrac UPA-150” (manufactured by NIKKISO Co., Ltd.).

### (b) Step of Preparing Water-Based Dispersion of Fine Colorant Particles

This step is an optional step performed as needed when toner particles containing a colorant are desired. In this step, the colorant in a fine particle form is dispersed in a water-based medium to prepare a water-based dispersion of the fine colorant particles.

The water-based dispersion of the fine colorant particles is obtained by dispersing the colorant in a water-based medium containing a surfactant at a critical micelle concentration (CMC) or higher.

The colorant may be dispersed by utilizing mechanical energy, and no particular limitation is imposed on the disperser used. As preferred examples of the disperser, may be mentioned an ultrasonic disperser, a mechanical homogeniser, pressurizing dispensers such as a Manton-Gaulin homogenizer and a pressure-type homogenizer and medium-type dispersers such as a sand grinder, a Getzmann mill and a diamond fine mill.

The dispersed fine colorant particles hare a volume-based median diameter of preferably 10 to 300 nm, more preferably 100 to 200 nm, particularly preferably 100 to 1.50 nm.

The volume-based median diameter of the fine colorant particles is a value measured using an electrophoretic light-scattering photometer “ELS-800” (manufactured by Otsuka Electronics Co., Ltd.).

### (c) Step of Preparing Water-Based Dispersion of Fine Amorphous Resin Particles

In this step, the water-based, dispersion of the fine amorphous resin particles formed of the amorphous resin is prepared.

The water-based dispersion of the fine amorphous resin particles can be prepared by first, synthesizing the amorphous resin and then dispersing the amorphous resin in fine particle form in a water-based medium.

As examples of the method of dispersing the amorphous resin in the water-based medium, may be mentioned a method including dissolving or dispersing the amorphous resin in an organic solvent to prepare an oil phase solution, dispersing the oil phase solution in a water-based medium by, for example, phase inversion emulsification to form oil droplets with their particle diameter controlled to the desired value, and then removing the organic solvent.

The average particle diameter, i.e., the volume-based median diameter, of the fine amorphous resin particles is preferably within the range of 80 to 230 nm.

The volume-based median diameter of the fine amorphous resin particles is a value measured using “Microtrac UPA-150” (manufactured by NIKKISO Co., Ltd.).

### (d) Step of Preparing Water-Based Dispersion of Fine Crystalline Polyester Resin Particles

In this step, the water-based dispersion of the fine crystalline polyester resin particles formed of the crystalline polyester resin is prepared.

The water-based dispersion of the fine crystalline polyester resin particles can be prepared by first synthesizing the crystalline polyester resin and dispersing the crystalline polyester resin in fine particle form in a water-based medium.

As examples of the method of dispersing the crystalline polyester resin in the water-based medium, may be mentioned a method including dissolving or dispersing the crystalline polyester resin in an organic solvent to prepare an oil phase solution, dispersing the oil phase solution in a water-based medium by, for example, phase inversion emulsification to form oil droplets with their particle diameter controlled to the desired value, and then removing the organic solvent.

The amount used of the water-based medium is preferably 50 to 2,000 parts by mass, more preferably 100 to 1,000 parts by mass per 100 parts by mass of the oil phase solution.

For the purpose of improving the dispersion stability of the oil droplets, a surfactant etc. may be added to the water-based medium. As examples of the surfactant, may be mentioned those exemplified in the above step.

The organic solvent used to prepare the oil phase solution is preferably a low-boiling point solvent with low solubility in water, from the viewpoint of ease of removal after formation of the oil droplets. As specific examples of such a solvent, may be mentioned methyl acetate, ethyl acetate, methyl ethyl ketone, methyl isobutyl ketone, toluene and xylene. These solvents may be used either singly or in any combination thereof. The amount used of the organic solvent is generally 1 to 300 parts by mass, preferably 1 to 100 parts by mass, more preferably 25 to 70 parts by mass per 100 parts by mass of the crystalline polyester resin.

Emulsification and dispersion of the oil phase solution may be performed by utilizing mechanical energy. No particular limitation is imposed on the dispenser used for emulsification and dispersion. As examples of the dispenser, may be mentioned a low-speed shear disperser, a high-speed shear disperser, a frictional disperser, a high-pressure jet disperser and an ultrasonic disperser. As specific examples of the disperser, may be mentioned a TK-type homomixer (manufactured by Tokushu Kika Kogyo Co., Ltd.).

The dispersion diameter of the oil droplets is preferably 60 to 1,000 nm, more preferably 80 to 500 nm.

The dispersion diameter of the oil droplets is a volume-based median diameter measured using a laser diffraction/scattering particle size distribution measurement device “LA-750” (manufactured by HORIEA Ltd.). The dispersion diameter of the oil droplets can be controlled by changing the mechanical energy during emulsification dispersion.

The average particle diameter, i.e., the volume-based median diameter, of the fine crystalline polyester resin particles is preferably within the range of 20 to 400 nm.

The volume-based median diameter of the fine crystalline polyester resin particles is a value measured using “Microtrac UPA-150” (manufactured by NIKKISO Co., Ltd.).

### (e) Step of Forming Toner Particles

In this step, the fine resin particles, the fine amorphous resin particles, the fine crystalline polyester resin particles and, if necessary, the fine colorant particles are aggregated and fusion-bonded by heat to form toner particles.

More specifically, an aggregating agent is added at a concentration equal to or higher than a critical aggregation concentration to a water-based dispersion containing the above-described fine particles dispersed in a water-based medium, and the mixture is heated to aggregate and fusion-bond the fine particles.

Preferably, the fusion bonding temperature is, for example, 80 to 95° C.

In this step, individual fine amorphous resin particles or a plurality of fused fine amorphous resin particles and individual fine crystalline polyester resin particles or a plurality of fused fine crystalline polyester resin particles form the domain phases (the first domain phase and the second domain phase).

The (meth)acrylate-based monomer represented by general formula (1) stove has high polarity with respect to water. When, the (meth)acrylate-based monomer is used for the polymerised vinyl segment in the amorphous resin, the polymerized vinyl segment parts in the amorphous resin are more likely to be oriented toward the water-based medium during formation of the domain phases, and the amorphous polyester segment parts are more likely to be oriented, toward the crystalline polyester resin. Therefore, a larger number of domains of the first domain phase 12a formed of the amorphous resin are allowed to be present, around domains of the second domain phase 12b formed of the crystalline polyester resin. In addition, the domains of the first domain phase 12a formed of the amorphous resin are formed so as to surround the domains of the second domain phase 12b formed of the crystalline polyester resin.

By adjusting the ester group concentration in the crystalline polyester resin to 0.1 to 7.1 mmol/g, the above effect can also be obtained.

The average diameter of domains of the domain phases in the toner particles formed in this step is preferably within the range of 0.2 to 1.0 μm.

The average diameter of domains of the domain phases is a value measured in an image observed under a transmission electron microscope (TEM).

### Aggregating Agent:

No particular limitation is imposed on the aggregating agent used in this step. An aggregating agent selected from metal salts such as salts of alkali metals and salts of alkaline-earth metals is preferably used. As examples of the metal salts, may be mentioned: salts of monovalent metals such as sodium, potassium and lithium; salts of divalent metals such as calcium, magnesium, manganese and copper; and salts of trivalent metals such as iron and aluminum. As specific examples of the metal salts, may be mentioned sodium chloride, potassium chloride, lithium chloride, calcium chloride, magnesium, chloride, sine chloride, copper sulfate, magnesium sulfate and manganese sulfate. Of these, salts of divalent metals are particularly preferably used because only a small amount of such a salt allows aggregation to proceed. These may be used either singly or in any combination thereof.

### (f) Aging Step

This step is performed as needed. In the aging step, the toner particles obtained in the toner particle forming step are aged using thermal energy until the desired shape is obtained.

More specifically, the aging treatment, is performed by heating and stirring the system containing the toner particles dispersed therein. The aging treatment is performed until the toner particles have the desired circularity while the heating temperature, stirring rate, heating time, etc. are controlled.

### (g) Cooling Step

In this step, the dispersion of the toner particles is subjected to cooling treatment. Preferably, the cooling treatment is performed under the condition of a cooling rate of 1 to 20° C./min. No particular limitation is imposed on the specific method for cooling treatment. As examples of the method, may be mentioned a cooling method in which a coolant is introduced from the outside of a reaction container and a cooling method in which cold water is directly introduced into the reaction system.

### (h) Filtration and Washing Step

In this step, the cooled dispersion of the toner particles is subjected to solid-liquid separation to separate the toner particles, and a toner cake obtained by solid-liquid separation (cake-like wet aggregates of the associated toner particles) is washed to remove adhering materials such as the surfactant and the aggregating agent.

No particular limitation is imposed on the solid-liquid separation method, and any of a centrifugation method, a vacuum filtration method using, for example, a suction funnel, and a filtration method using, for example, a filter press may be used. Preferably, washing is performed with water until the electric conductivity of the filtrate becomes 10 μS/cm.

### (i) Drying Step

In this step, the toner cake subjected to washing treatment is dried. This step may be performed according to a general, drying step used in a publicly known, production process of toner particles.

As specific examples of the dryer used to dry the toner cake, may be mentioned a spray dryer, a vacuum freeze dryer and a vacuum dryer. Preferably, any of a stationary shelf dryer, a movable shelf dryer, a fluidized-bed dryer, a rotary dryer and a stirring dryer is used.

The content of water in the dried toner particles is preferably 5% by mass or lower, more preferably 2% by mass or lower. When the dried toner particles are aggregated together through weak interparticle attractive force, the aggregates may be subjected to pulverization treatment. The pulverizer used may be a mechanical pulveriser such as a jet mill, a Henschel mixer, a coffee mill or a food processor.

### (j) Step of Adding External Additives

This step is an optional step performed as needed when external additives are added to the toner particles.

The above toner particles can be used as a toner without adding any additive. However, the toner particles may be used with external additives such as a flowability improver and a cleaning aid added thereto, in order to improve flowability, charge property, cleanability, etc.

A combination of various external additives may be used.

The total amount of the external additives added is preferably 0.05 to 5 parts by mass, more preferably 0.1 to 3 parts by mass per 100 parts by mass of the toner particles.

The mixer used for the external additives may be a mechanical mixer such as a Henschel mixer or a coffee mill.

In the toner described above, the toner particles 10 contain the crystalline polyester resin, so that low-temperature fixability is basically obtained. Since the crystalline polyester resin and the vinyl resin forming the matrix phase 11 are immiscible with each other, the crystalline polyester resin does not plasticize the vinyl resin constituting the matrix phase 11 before neat fixation (for example, during storage of the toner), so that heat-resistant storage stability can be ensured. Since a large number of domains of the first domain phase 12a formed of the amorphous resin are present around the domains of the second domain phase 12b formed of the crystalline polyester resin, exposure of the crystalline polyester resin at the surface of the toner particles 10 is suppressed, so that long-term stable electrification performance is obtained. In addition, in the amorphous resin constituting the first domain phase 12a, the affinity of the polymerized vinyl segment parts of the amorphous resin for the vinyl resin in the matrix phase is high, and the affinity of the amorphous polyester segment parts of the amorphous resin for the crystalline polyester is high. Therefore, the overall affinity in the toner particles 10 is high, and nonuniformity in melt viscosity of the resins in the toner particles is small. Particularly, the occurrence of unevenness in gloss on a rough paper sheet can be suppressed.

The embodiment of the present invention has been specifically described. However, the embodiment of the present invention is not limited to the examples described above, and various modifications can be made thereto.

### EXAMPLES

Specific Examples of the present invention will next be described, but the present invention is not limited thereto.

The volume-based median diameters of the fine resin particles, the fine colorant particles, the fine amorphous resin particles and the fine crystalline polyester resin particles were measured in the manner described above, and the molecular weights of the fine resin particles, the amorphous resin and the crystalline polyester resin were measured in the manner described above.

The glass transition points (Tg) of the fine resin particles, the amorphous resin and the toner, the melting point (Tm) of the crystalline polyester resin and the softening point (Tsp) of the amorphous resin were measured in the manners described above.

The average diameters of the domain phases were measured in the manner described above.

The ester group concentration of the crystalline polyester resin was measured in the manner described above.

### Production Example 1 of Toner

### (1) Preparation of Water-Based Dispersion [1] of Fine Resist Particles

### First Polymerization:

A 1 L reaction vessel equipped with a stirrer, a temperature sensor, a condenser tube and a nitrogen introduction device was charged with a solution prepared by dissolving 1.5 parts by mass of sodium polyoxyethylene (2) dodecyl ether sulfate in 560 parts by mass of ion exchanged water, and the temperature inside the vessel was increased to 80° C. while the mixture was stirred at a stirring rate of 300 rpm under nitrogen flow. After the temperature was increased, a solution prepared by dissolving 1.9 parts by mass of potassium persulfate in 37 parts by mass of ion exchanged water was added, and the temperature of the mixture was again increased to 80° C. A solution mixture of the following monomers was added dropwise over 1 hour, and the resultant mixture was heated at 90° C. for two hours and stirred to perform polymerization, whereby a dispersion (a) of fine resin particles was prepared.

| | |
|---|---|
| Styrene | 113 parts by mass |
| n-Butyl acrylate | 32 parts by mass |
| Methacrylic acid | 13.6 parts by mass |

### Second Polymerization:

A 5 L reaction vessel equipped with a stirrer, a temperature sensor, a condenser tube and a nitrogen introduction device was charged with a solution prepared by dissolving 7.4 parts by mass of sodium polyoxyethylene (2) dodecyl ether sulfate in 970 parts by mass of ion exchanged water, and the solution was heated, to 98° C. Then 285 parts by mass of the dispersion (a) of the fine resin particles and a solution prepared by dissolving a solution mixture of the following monomers at 90° C. were added, and the mixture was mixed and dispersed for 1 hour using a mechanical disperser having a circulation path “CLEARMIX” (manufactured by M Technique Co., Ltd.) to prepare a dispersion containing emulsified particles (oil droplets).

| | |
|---|---|
| Styrene | 284 parts by mass |
| n-Butyl acrylate | 92 parts by mass |
| Methacrylic acid | 15.7 parts by mass |
| n-Octyl-3-mercaptopropionate | 4.2 parts by mass |
| “HNP-0190” (manufactured by | 120 parts by mass |
| Nippon Seiro Co., Ltd.) | |

Then an initiator solution prepared by dissolving 6.6 parts by mass of potassium persulfate in 126 parts by mass of ion exchanged water was added to the obtained dispersion. The resultant system was heated and stirred at 84° C. for 1 hour to perform polymerisation, and a dispersion [b] of fine resin particles was thereby prepared.

### Third Polymerisation:

A solution prepared by dissolving 12 parts by mass of potassium persulfate in 290 parts by mass of ion exchanged water was further added, and a monomer solution mixture of 390 parts by mass of styrene, 180 parts by mass of n-butyl acrylate, 30 parts by mass of methacrylic acid and 8.6 parts by mass of n-octyl-3-mercaptopropionate was added dropwise over 1 hour under a temperature condition of 82° C. After completion of dropwise addition, the mixture was heated and stirred for 2 hours to perform polymerisation. Then the mixture was cooled to 23° C. to obtain a water-based dispersion [1] of fine resin particles formed of the vinyl resin.

In the obtained water-based dispersion [1], the glass transition point (Tg) of the fine resin particles was 50° C. The average particle diameter (volume-based median diameter) thereof was 220 nm, and the weight average molecular weight (Mw) thereof was 59,500.

### (2) Preparation of Water-Based Dispersion [Bk] of Fine Colorant Particles

90 Parts by mass of sodium dodecyl sulfate was added to 1,600 parts by mass of ion exchanged water. 420 Parts by mass of carbon black (“REGAL 330R,” manufactured by Cabot Corporation) was gradually added to the obtained solution under stirring, and then the mixture was subjected to dispersion treatment using a stirrer “CLEARMIX” (manufactured by M Technique Co., Ltd.) to thereby prepare a water-based dispersion [Bk] of fine colorant particles.

The average particle diameter (the volume-based median diameter) of the fine colorant particles in the water-based dispersion [Bk] was 110 nm.

### (3) Preparation of Water-Based Dispersion [1] of Fine Amorphous Resin Particles

### (3-1) Synthesis of Amorphous Resin:

A monomer solution mixture containing the following components, i.e., vinyl monomers for forming the polymerized vinyl segment, a both-reactive monomer and a radical polymerisation initiator, was placed in a dropping funnel.

| | |
|---|---|
| Acrylic acid | 5 parts by mass |
| Styrene | 75 parts by mass |
| Butyl acrylate | 26 parts by mass |
| Polymerization initiator (di-t-butyl peroxide) | 16 parts by mass |

The following monomers for forming the amorphous polyester segment were placed in a 10 L four-neck flask equipped with a nitrogen introduction tube, a dewatering tube, a stirrer and a thermocouple.

| | |
|---|---|
| 2-Mole propylene oxide adduct of bisphenol A | 288 parts by mass |
| Terephthalic acid | 69 parts by mass |
| Fumaric acid | 48 parts by mass |
| Esterification catalyst (tin octylate) | 1.5 parts by mass |

Temperature was increased to 170° C., which corresponds to the addition polymerization reaction temperature. Then the monomer solution was added dropwise from the dropping funnel under stirring over 90 minutes, and then aging was performed for 60 minutes.

Then 40 g of tin octylate used as the esterification catalyst was added, and the mixture was heated to 235° C. to allow a reaction to proceed at normal pressure (101.3 kPa) for 5 hours and then under reduced pressure (8 kPa) for 1 hour.

The mixture was cooled to 200° C., and the reaction was allowed to proceed under reduced pressure (20 kPa) until the desired softening point was obtained, whereby an amorphous resin [1] was obtained.

The glass transition point (Tg) of the amorphous resin [1] was 56° C. Its softening point (Tsp) was 100° C., and its weight average molecular weight (Mw) was 12,300.

### (3-2) Preparation of Water-Based Dispersion of Fine Amorphous Resin Particles:

30 Parts by mass of the amorphous resin [1] was melted, and the molten amorphous resin [1] was transferred to an emulsification disperser “CAVITRON CD1010” (manufactured by EUROTEC Co., Ltd.) at a transfer rate of 100 parts by mass per minute. At the same time as the transfer of the molten amorphous resin. [1], diluted ammonia water was transferred to the emulsification disperser at a transfer rate of 0.1 L per minute while the diluted ammonia, water was heated at 100° C. in a heat exchanger. Note that the diluted ammonia water was prepared by diluting 70 parts by mass of an ammonia water reagent with ion exchanged water in a water-based solvent tank to have a concentration of 0.37% by mass. The emulsification disperser was operated under the conditions of a rotor rotation speed of 60 Hz and a pressure of 5 kg/cm² to prepare a water-based dispersion [1] of fine amorphous resin particles having a volume-based median diameter of 200 nm. The solid content in the water-based dispersion [1] was 30 parts by mass.

### (4) Preparation of Water-Based Dispersion [1] of Fine Crystalline Polyester Resin Particles

### (4-1) Synthesis of Crystalline Polyester Resin;

A 5 L reaction vessel equipped with a stirrer, a temperature sensor, a condenser tube and a nitrogen introduction device was charged with 300 parts by mass of polyvalent carboxylic acid (sebacic acid, molecular weight: 202.25) and 170 parts by mass of polyhydric alcohol (1,6-hexanediol, molecular weight: 118.17). While the system, was stirred, the temperature inside the vessel was increased to 190° C. over 1 hour. After it was confirmed that the system was uniformly stirred, Ti(OBu)₄ used as a catalyst was added in an amount of 0.003% by mass with respect to the amount charged of the polyvalent carboxyl acid. Then, while water generated was removed by evaporation, the internal temperature was increased from 190° C. to 240° C. over 6 hours, and a dehydration condensation reaction was performed continuously under a temperature condition of 240° C. for 6 hours to perform polymerisation, whereby a crystalline polyester resin [1] was obtained.

The melting point (Tm) of the obtained crystalline polyester resin [1] was 66.8° C., and its number average molecular weight (Mn) was 6,300.

### (4-2) Preparation of Water-Based Dispersion of Fine Crystalline Polyester Resin Particles:

30 Parts by mass of the crystalline polyester resin [1] was melted, and the molten crystalline polyester resin [1] was transferred to an emulsification disperser “CAVITRON CD1010” (manufactured by EUROTEC Co., Ltd.) at a transfer rate of 100 parts by mass per minute. At the same time as the transfer of the molten crystalline polyester resin [1], diluted ammonia water was transferred to the emulsification disperser at a transfer rate of 0.1 L per minute while the diluted ammonia water was heated at 100° C. in a heat exchanger. Mote that the diluted ammonia, water was prepared by diluting 70 parts by mass of an ammonia, water reagent with ion exchanged water in a water-based solvent tank to have a concentration of 0.37% by mass. The emulsification disperser was operated under the conditions of a rotor rotation speed of 60 Hz and a pressure of 5 kg/cm² to prepare a water-based dispersion [1] of fine crystalline polyester resin particles having a volume-based median diameter of 200 nm. The solid content in the water-based dispersion [1] was 30 parts by mass,

### (5) Production of Toner Particles [1]

A 5 L reaction vessel equipped with a stirrer, a temperature sensor, a condenser tube and a nitrogen introduction device was charged with 252 g (in terms of solids) of the water-based dispersion [1] of the fine resin particles, 54 g (in terms of solids) of the water-based dispersion [1] of the fine amorphous resin particles, 54 g (in terms or solids) of the water-based dispersion [1] of the fine crystalline polyester resin particles, 1,100 g of ion exchanged water and 40 g (in terms of solids) of the water-based dispersion [Bk] of the fine colorant particles. After the temperature of the solution was adjusted to 30° C., a 5N aqueous sodium hydroxide solution was added to adjust the pH to 10. Then an aqueous solution prepared by dissolving 60 g of magnesium chloride in 60 g of ion exchanged waiter was added at 30° C. over 10 minutes under stirring, after the solution was held for 3 minutes, the temperature was increased. The temperature of the system was increased over 60 minutes to 85° C., and a particle growth reaction was continued while the temperature was maintained at 85° C. While this state was maintained, the particle diameter of associated particles was measured using “Coulter Multisizer 3” (manufactured by Beckman Coulter, Inc.). When the volume-based median diameter reached 6 μm, an aqueous solution prepared by dissolving 40 g of sodium chloride in 160 g of ion exchanged water was added to terminate the particle growth. Then, the aging step was performed. Specifically, the solution was heated and stirred at a solution temperature of 80° C. for 1 hour to allow fusion bending of the particles to proceed, whereby toner particles [1] were formed.

The produced toner particles [1] were subjected to solid-liquid separation using a basket-type centrifuge “MARK III TYPE 60×40” (manufactured by Matsumoto Machine Manufacturing Co., Ltd.) to form a wet cake of the toner particles. The wet cake was washed with ion exchanged water at 40° C. in the basket-type centrifuge until the electric conductivity of the filtrate reached 5 μS/cm. Then, the wet cake was transferred to a “flash jet dryer” (manufactured by Seishin Enterprise Co., Ltd.) to dry the cake until the water content became 0.5% by mass.

1% By mass of hydrophobic silica particles and 1.2% by mass of hydrophobic titanium oxide particles were added to the dried toner particles [1], and these particles were mixed, using a Henschel mixer for 20 minutes under the condition of a peripheral speed of a rotary blade of 24 m/s and were caused to pass through a 400 mesh sieve to thereby add the external additives, whereby a toner [1] was obtained.

The glass transition point (Tg) of the toner [1] was 45° C.

Although the external additives were added to the toner [1], the shape and diameter of the toner particles were not changed.

### Production Examples 2 to 10 of Toner

Toners [2] to [10] were obtained in the same manner as in Production Example 1 of the toner except that the type of water-based dispersion of fine amorphous resin particles, the type of water-based dispersion of fine crystalline polyester resin particles and the amounts added of the respective water-based dispersions were changed as shown in TABLE 1.

The water-based dispersions [2] to [5] of fine amorphous resin particles in TABLE 1 were obtained by changing the composition of the monomers used in (3-1) synthesis of the amorphous resin in Production Example 1 of the toner as shown in TABLE 2.

The water-based dispersions [2] to [3] of fine crystalline polyester resin particles in TABLE 1 were obtained by changing the composition of the monomers used in (4-1) synthesis of the crystalline polyester resin in Production Example 1 of the toner as shown in TABLE 3.

TABLE 1

| | | | | | | WATER-BASED | | | | |
|---|---|---|---|---|---|---|---|---|---|---|
| | | WATER-BASED | | WATER-BASED | | DISPERSION OF | | COMPOSITIONAL RETIO OF RESINS | | |
| | | DISPERSION OF | | DISPERSION OF | | FINE CRYSLTALLINE | | (% BY MASS) | | |
| | | FINE RESIN | | FINE AMOURPHOUS | | POLYESTER | | MATRIX | | |
| | | PARTICLES | | RESIN PARTICLES | | RESIN PARTICLES | | PHASE | DOMAIN PHASE | |
| | | | AMOUT | | AMOUT | | AMOUT | VINYL- | AMOR- | CRYSLTALLINE |
| TONER | Tg | | ADDED | | ADDED | | ADDED | BASED | PHOUS | POLYESTER |
| NO. | (° C.) | No. | (g) | No. | (g) | No. | (g) | RESIN | RESIN | RESIN |
| TONER[1] | 45 | [1] | 252 | [1] | 54 | [1] | 54 | 70 | 15 | 15 |
| TONER[2] | 38 | [1] | 252 | [1] | 72 | [2] | 36 | 70 | 20 | 10 |
| TONER[3] | 25 | [1] | 252 | [1] | 36 | [3] | 72 | 70 | 10 | 20 |
| TONER[4] | 50 | [1] | 216 | [2] | 72 | [1] | 72 | 60 | 20 | 20 |
| TONER[5] | 33 | [1] | 144 | [3] | 108 | [1] | 108 | 40 | 30 | 30 |
| TONER[6] | 38 | [1] | 252 | [4] | 54 | [1] | 54 | 70 | 15 | 15 |
| TONER[7] | 40 | [1] | 252 | [5] | 54 | [1] | 54 | 70 | 15 | 15 |
| TONER[8] | 23 | [1] | 288 | — | — | [1] | 72 | 80 | 0 | 20 |
| TONER[9] | 45 | [1] | 288 | [1] | 72 | — | — | 80 | 20 | 0 |
| TONER[10] | 55 | [1] | 360 | — | — | — | — | 100 | 0 | 0 |

TABLE 2

| | AMORPHOUS POLYESTER | | | | | | | | | |
|---|---|---|---|---|---|---|---|---|---|---|
| | SEGMENT | | | | | | | | | |
| | POLYHYDRIC | | | | | | | | | |
| | ALCOHOL | | | POLYMERIZED VINYL | | | BOTH- | | | |
| WATER-BASED | (PARTS BY | POLYVALENT | | SEGMENT | | | REACTIVE | | | |
| DISPERSION | MASS) | CARBOXYLIC ACID | | COMPOSITION | | | MONOMER | | | |
| NO. OF FINE | PROPYLENE | (PARTS BY MASS) | | (PARTS BY MASS) | | | ACRYLIC | | | |
| AMOUPHOUS | OXIDE | TERE- | FU- | | BUTYL | CONTENT | ACID | | | |
| RESIN | ADDUCT OF | PHTHALIC | MARIC | | ACRY- | (% BY | (PARTS BY | Tg | T [symbol] | |
| PARTICLES | BISPHENOL A | ACID | ACID | STYRENE | LATE | MASS) | MASS) | (° C.) | (° C.) | Mw |
| WATER-BASED | 288 | 89 | 48 | 75 | 28 | 20 | 5 | 56 | 100 | 12300 |
| DISPERSION | | | | | | | | | | |
| [1] OF FINE | | | | | | | | | | |
| AMOUPHOUS | | | | | | | | | | |
| RESIN | | | | | | | | | | |
| PARTICLES | | | | | | | | | | |
| WATER-BASED | 256 | 80 | 43 | 114 | 38 | 30 | 8 | 60 | 103 | 18000 |
| DISPERSION | | | | | | | | | | |
| [2] OF FINE | | | | | | | | | | |
| AMOUPHOUS | | | | | | | | | | |
| RESIN | | | | | | | | | | |
| PARTICLES | | | | | | | | | | |
| WATER-BASED | 346 | 81 | 58 | 28 | 8 | 6 | 2 | 52 | 98 | 13400 |
| DISPERSION | | | | | | | | | | |
| [3] OF FINE | | | | | | | | | | |
| AMOUPHOUS | | | | | | | | | | |
| RESIN | | | | | | | | | | |
| PARTICLES | | | | | | | | | | |
| WATER-BASED | 357 | 84 | 60 | 8 | 3 | 2 | 1 | 48 | 94 | 15200 |
| DISPERSION | | | | | | | | | | |
| [4] OF FINE | | | | | | | | | | |
| AMOUPHOUS | | | | | | | | | | |
| RESIN | | | | | | | | | | |
| PARTICLES | | | | | | | | | | |
| WATER-BASED | 364 | 86 | 61 | 0 | 0 | 0 | 0 | 42 | 90 | 10200 |
| DISPERSION | | | | | | | | | | |
| [5] OF FINE | | | | | | | | | | |
| AMOUPHOUS | | | | | | | | | | |
| RESIN | | | | | | | | | | |
| PARTICLES | | | | | | | | | | |

[symbol]

indicates data missing or illegible when filed

TABLE 3

| | COMPOSITION | | | | | | | | |
|---|---|---|---|---|---|---|---|---|---|
| WATER-BASED | POLYVALENT | | | POLYHDRIC | | | | | |
| DISPERSION | CARBOXYLIC ACID | | | ALCOHOL | | | ESTER | | |
| NO. OF FINE | | | AMOUNT | | | AMOUNT | GROUP | | |
| CRYSLTALLINE | | MOLEC- | ADDED | | MOLEC- | ADDED | CONCEN- | | |
| POLYESTER | | ULAR | (PARTS BY | | ULAR | (PARTS BY | TRATION | Tm | |
| RESIN PARTICLES | TYPE | WEIGHT | MASS) | TYPE | WEIGHT | MASS) | (mmol/g) | (° C.) | Mn |
| WATER-BASED | SEBACIC | 202.25 | 300 | 1,6-HEXANE- | 118.17 | 170 | 7.03 | 68.8 | 6300 |
| DISPERSION | ACID | | | DIOL | | | | | |
| [1] OF FINE | | | | | | | | | |
| CRYSLTALLINE | | | | | | | | | |
| POLYESTER | | | | | | | | | |
| RESIN PARTICLES | | | | | | | | | |
| WATER-BASED | DODECANE- | 230.3 | 342 | 1,12-DODECANE- | 202.33 | 291 | 5.04 | 84.9 | 7500 |
| DISPERSION | DIOIC | | | DIOL | | | | | |
| [2] OF FINE | ACID | | | | | | | | |
| CRYSLTALLINE | | | | | | | | | |
| POLYESTER | | | | | | | | | |
| RESIN PARTICLES | | | | | | | | | |
| WATER-BASED | SEBACIC | 202.25 | 300 | ETHYLENE | 82.07 | 88 | 8.76 | 75.0 | 4000 |
| DISPERISON | ACID | | | GLYCOL | | | | | |
| [3] OF FINE | | | | | | | | | |
| CRYSLTALLINE | | | | | | | | | |
| POLYESTER | | | | | | | | | |
| RESIN PARTICLES | | | | | | | | | |

### Production Examples 1 to 10 of Developer

Developers [1] to [10] were produced by adding a ferrite carrier having a volume-based median diameter of 60 μm and coated with a silicons resin to each of the toners [1] to [10] such that the concentration of the toner was 6% by mass and then mixing them using a V-type mixer.

### Examples 1 to 6 and Comparative Examples 1 to 4

### (1) Evaluation of Low-Temperature Fixability

One of the developers [1] to [10] was installed, in a copier “bizhub PRO C6550” (manufactured by Konica Minolta Business Technologies, Inc.) including a fixing unit that was modified such that the surface temperature (fixation temperature) of heating rollers could be changed in the range of 120 to 200° C.

A fixation, experiment, was performed in a room temperature-room humidity environment (temperature: 20° C., humidity: 50% RH). More specifically, solid images with a toner adhesion amount of 8 mg/cm² were fixed on an A4 high-quality paper sheet “CF paper” (manufactured by Konica Minolta, Inc.) and an embossed paper sheet “LEATHAC 66” (manufactured by Tokushu Tokai Paper Co., Ltd.). The fixation experiment was repeated at different fixation temperature settings, i.e., the fixation temperature was increased from 120° C. to 200° C. in steps of 5° C.

In the results of the fixation experiment in which no image contamination due to cold offset was visually observed, the lowest one of the fixation temperatures was evaluated as the lowest fixable temperature. A developer having a lowest fixing temperature of 140° C. or lower wee judged as pass. The results are shown in TABLE 4.

### (2) Evaluation of Long-Term Stability of Electrification

A copier “bizhub PRO C6550” (manufactured by Konica Minolta Business Technologies, Inc.) with one of the developers [1] to [10] installed was used.

A text image having a coverage rate of 10% was printed continuously on 100,000 A4 paper sheets in a high temperature-high humidity environment (temperature: 30° C., humidity: 85% RH). Then a test image including a white image and a halftone image was printed. Togging was checked in the printed images, and image roughness of the halftone image was checked. The results were evaluated using the following evaluation criteria. The results are shown in TABLE 4.

### —Evaluation Criteria—

A: No reduction in image density and no fogging were visually observed.

B: A slight reduction in image density and/or slight fogging was observed under a 20× loupe but was practically acceptable.

C: A reduction in image density and/or fogging was visually observed but was practically acceptable.

D: A reduction in image density and fogging were visually observed and were practically unacceptable.

### (3) Evaluation of Heat-Resistant Storage Stability:

0.5 g of one of the toners [1] to [10] was placed in a 10 mL glass bottle having an inner diameter of 21 mm, and the glass bottle was covered with a lid. The bottle was shaken using Tap Denser “KYT-2000” (manufactured by Seishin Enterprise Co., Ltd.) 600 times at room temperature. Then the toner was left to stand in an environment of a temperature of 55° C. and a humidity of 35% RH for 2 hours with the lid removed. Then the toner was placed with care on a 48 mesh sieve (aperture: 350 μm) such that the aggregates of the toner were not pulverized, and the sieve was placed on a “powder tester” (manufactured by Hosokawa Micron Group) and secured using a pressing bar and a knob nut. The strength, of vibrations was adjusted such that a feed, width was 1 mm, and vibrations were applied for 10 seconds. Then the amount of the toner remaining on the sieve was measured, and the aggregation ratio of the toner was computed using the following formula (2) and used for evaluation. The results are shown in TABLE 4.

aggregation ratio (% by mass) of toner={mass (g) of remaining toner)/0.5 (g)}×100 Formula (2)

A toner having an aggregation ratio of less than 15% was evaluated as very good, and a toner having an aggregation ratio of 15% by mass or more and 20% by mass or less was evaluated as good. When the aggregation ratio was larger than 20% by mass, the toner was not practically usable and was judged as failed.

### (4) Evaluation of Uniformity in Gloss:

The uniformity in gloss was evaluated by the same method as the method of evaluating the low-temperature fixability described above except that a fixed image obtained by setting the temperature of the fixation belt to a temperature higher by 20° C. than the temperature at which low-temperature offset occurred was used. The uniformity in gloss was evaluated by observing the presence or absence of unevenness in gloss visually or under a loupe according to the following criteria. The results are shown in TABLE 4.

### —Evaluation Criteria—

A: No unevenness in gloss was detected even by observation under a loupe with a signification of 20×.

B: Slight unevenness in gloss was detected by observation under a loupe with a magnification of 20×, but no unevenness in gloss was detected visually. The unevenness in gloss was at a level that did not cause any problem in image quality.

C: Slight unevenness in gloss was detected by visual observation.

D: Unevenness in gloss was clearly detected visually.

TABLE 4

| | | EVALUATION RESULTS | | | | | |
|---|---|---|---|---|---|---|---|
| | | LOW-TEMPERATURE | | | | | |
| | | FIXABILITY | | | HEAT RESISTANT | | |
| | | LOWEST FIXABLE | | LONG-TERM | STORAGE | | |
| | | TEMPERATURE (° C.) | | STABILITY OF | STABILITY | UNIFORMITY IN GLOSS | |
| | TONER | HIGH-QUALITY | EMBOSSED | ELECTRIFI- | AGGREGATION | HIGH-QUALITY | EMBOSSED |
| | NO. | PAPER | PAPER | CATION | RATIO (%) | PAPER | PAPER |
| EXAMPLE 1 | TONER[1] | 110 | 120 | A | 8.0 | A | A |
| EXAMPLE 2 | TONER[2] | 115 | 125 | A | 3.0 | A | A |
| EXAMPLE 3 | TONER[3] | 105 | 115 | A | 12.0 | A | A |
| EXAMPLE 4 | TONER[4] | 105 | 115 | A | 5.0 | A | A |
| EXAMPLE 5 | TONER[5] | 105 | 110 | B | 15.0 | B | B |
| EXAMPLE 6 | TONER[6] | 110 | 125 | B | 18.0 | B | B |
| COMPARATIVE | TONER[7] | 110 | 140 | D | 25.0 | A | B |
| EXAMPLE 1 | | | | | | | |
| COMPARATIVE | TONER[8] | 115 | 145 | D | 35.0 | B | C |
| EXAMPLE 2 | | | | | | | |
| COMPARATIVE | TONER[9] | 130 | 155 | A | 5.0 | A | A |
| EXAMPLES 3 | | | | | | | |
| COMPARATIVE | TONER[10] | 160 | 180 | A | 2.0 | A | A |
| EXAMPLE 4 | | | | | | | |

### REFERENCE SIGNS LIST

10 Toner particle
11 Matrix phase
12 Domain, phase
12a First domain phase
12b Second domain phase

1. A toner for electrostatic image development, comprising toner particles having a domain-matrix structure, wherein,
in the toner particles, a crystalline polyester resin and an amorphous resin including an amorphous polyester segment and a polymerised vinyl segment that are chemically bonded are dispersed as domain phases in a matrix phase including a vinyl resin.

2. The toner for electrostatic image development according to claim 1, wherein a mass ratio of the crystalline polyester resin to the amorphous resin that constitute the domain phases, being (the crystalline polyester resin/the amorphous resin), is 10/90 to 80/20.

3. The toner for electrostatic image development according to claim 1, wherein a content of the crystalline polyester resin with respect to a total amount of the resins constituting the toner particles is 5 to 30% by mass.

4. The toner for electrostatic image development according to claim 1, wherein a content of the polymerized vinyl segment in the amorphous resin is 5 to 30% by mass.

5. The toner for electrostatic image development according to claim 1, wherein the polymerised, vinyl segment has a structural unit derived from a (math)acrylate-based monomer represented by a following general formula (1):
H₂C═C¹—COOR² general formula (1)
[in the general formula (1), R¹ represents a hydrogen atom or a methyl group, and R² represents an alkyl group having 1 to 8 carbon atoms].

6. The toner for electrostatic image development according to claim 1, wherein an ester group concentration in the crystalline polyester resin is 0.1 to 7.1 mmol/g.

7. A production process of a toner for electrostatic image development, comprising a step of aggregating and fusion-bonding fine particles of a vinyl resin, fine particles of an amorphous resin including an amorphous polyester segment and a polymerised vinyl segment that are chemically bonded and fine particles of a crystalline polyester resin in a water-based medium.

8. The production process of a toner for electrostatic image development according to claim 7, wherein the polymerised vinyl segment has a structural unit derived from a (meth)acrylate-based monomer represented by a following general formula (1):
H₂C═CR¹—COOR² general formula (1)
[in the general formula (1), R¹ represents a hydrogen atom or a methyl group, and R² represents an alkyl group having 1 to 8 carbon atoms].

9. The production process of a toner for electrostatic image development according to claim 7, wherein an ester group concentration in the crystalline polyester resin is 0.1 to 7.1 mmol/g.
